(19) United States
(12) Patent Application Publication
(10) Pub. No.: US 2022/0282743 A1
(43) Pub. Date: Sep. 8, 2022

(54) FIRST FLUSH DIVERTER SYSTEM

(71) Applicant: SOLUCIÓN PLUVIAL, S. A. DE C. V., Mexico City (MX)

(72) Inventors: Enrique LOMNITZ CLIMENT, Mexico City (MX); Jesús Hiram GARCÍA VELÁZQUEZ, Mexico City (MX); Renata FENTON REGAN, Mexico City (MX)

(21) Appl. No.: 17/624,984

(22) PCT Filed: Jun. 5, 2020
(86) PCT No.: PCT/IB2020/055339

§ 371 Date: Jan. 5, 2022

(51) Int. Cl. F15D 1/14; E03B 3/02

(52) U.S. Cl. CPC F15D 1/14; E03B 3/02

(57) ABSTRACT

A system for diverting an adjustable number of liters of a first flush, which has a modular, in series or parallel configuration to expand the maximum adjustable capacity. Additionally, a rainwater collection system for delivery of said rainwater to a domestic system for use thereof. The system comprises first flush diverter, screening stage, filtering stages, buffering stage, settling/resting stage, disinfection and/or purification stage.

### CROSS REFERENCE TO RELATED APPLICATIONS

This application is a national stage application, filed under 35 U.S.C. § 371, of International Application No. PCT/M2020/055339, filed Jun. 5, 2020, the contents of which as are hereby incorporated by reference in their entirety.

### BACKGROUND

### Technical Field

The present invention relates to the field of mechanics and, more particularly, to devices and systems for catchment and use of rainwater falling on a roof-like surface, such as a rooftop, from where rainwater is redirected. The system includes stages of separating a specific volume of first flush, regardless of the rooftop type or size, including built-in systems for the use of rainwater that include filtration, screening, chlorination and/or purification stages.

### Description of Related Art

A system for catchment and use of rainwater, essentially comprising: collecting rainwater falling on a roof-like surface, such as a rooftop, to then be channeled by gravity into a site or reservoir, such as a cistern, and be subsequently delivered to another site for domestic use thereof. Hence, in order to be able to use this rainwater, it is necessary that during or after channeling of rainwater from the roof-like surface to the cistern, rainwater undergoes various cleaning stages to make it suitable for human consumption, keeping rainwater in that state for several months. One of these stages consists of separating a first flush from the remainder of the rainfall event, since this initial flow of rainwater contains contaminants and dirt accumulated on rooftops and in the environment.

Initial flow of rainwater or first-flush is defined as the first liters of rainwater per square meter (the number of liters per square meter may vary according to the local laws) that fall on a rooftop when it rains, i.e. this first flush comes into direct contact with air and a dry rooftop that has accumulated debris such as dust, leaves, etc., that the first flush “washes” away. In other words, this first flush is considered as dirty water or water that is not intended to be used by a rainwater catchment system and is therefore separated from the remainder of the rainfall event.

However, since rainwater falls on contact surfaces that vary in shape, dimensions, material, etc., the systems for catchment and use of rainwater have virtually acquired a tailor-made rather than a modular configuration for its first flush separation stage, thereby resulting in an increased price of the product and in impractical bulky apparatuses for household uses.

Apparatuses for the separation of first flush exist in the art, essentially comprising a first diverter container for diverting first flush before rainwater is directed into a cistern, that is, by using the same channeling, but firstly directing the rainwater to said first diverter container. In this way, when the first diverter container is full, the rainwater moves directly to the cistern. Therefore, the capacity of said first diverter container will determine the capacity of the first-flush diverter, such that a large rooftop or contact surface will require a diverter, that is, a first diverter container larger in size as compared with that for a surface with fewer square meters, i.e. the first flush diverters existing in the art are customized to fit the size of the rooftop where the rain will fall. Thus, PVC or plastic pipes are normally used, which may be cut to size and sealed on both ends to serve as a first diverter container. Therefore, the first flush diverters existing in the art are large and bulky.

To address this problem, utility model MX/u/2011/000451 claims a modular, scalable first flush diverter allowing for adjustment of the amount of water to be diverted with the use of a floating ball that, when reaching a certain level, prevents first flush from flowing through a pipe and directs the flow into another direction. However, the number of parts, the manufacture thereof, and the maintenance of the floating ball system becomes complicated in the medium and long term.

As a result, there is a need for a system that identifies and diverts in an adjustable manner the first flush of a rain event, wherein said system is not required to be custom-made, but instead the same system can be fitted to a rooftop having a maximum area and, if necessary, be modularly attached to another system when a rooftop exceeds a maximum surface. Thus, there is a need for one or more first flush diverter systems capable of being attached to each other and which can be used for rooftops with contact surfaces of any size, i.e. without limiting to a specific maximum surface size.

A key aspect in the systems for catchment and use of rainwater is gravity, since it allows for recovery from a high surface, such as a rooftop, of rainwater and the potential energy stored in it, without using electric power, and from there rainwater may flow down to a cistern where it essentially remains quiet. Thus, during its way down to the cistern, rainwater undergoes various important stages of separation, screening, settlement and/or cleaning in order to make it suitable for human consumption. Therefore, depending on how much water falls during a rain event, when the rainwater falls into a reservoir or cistern, it agitates the entire volume of water contained in it, such that the debris settled at the bottom of the reservoir or cistern are also agitated, causing that such debris are scattered throughout the entire the volume of water, directly affecting the settlement stage (i.e., the sediments are no longer located at the bottom), thereby contaminating essentially the total volume of water. Thus, the recovered rainwater is required to undergo a dampening when it falls, i.e. that the flow of rainwater in free fall motion does not agitate or avoids agitating the rest of the water, such that the debris settled at the bottom are not scattered, and the settlement stage is minimally or not affected. There is a further need to damper or minimize the impact caused by falling rainwater or its speed as it falls into the water contained in a reservoir or cistern.

There is an additional need to provide a system for catchment and domestic use of rainwater that incorporates everything as may be necessary for immediate use of rainwater, from a stage of first flush self-cleaning, identification and diversion, and at least one stage of filtering and delivery of rainwater into an underground cistern, with or without the use of a dampening stage, to the provision of all mechanical and/or electromechanical means so that the rainwater so captured is delivered to a household's piping system for domestic use thereof.

### BRIEF SUMMARY

Various embodiments of the present invention are directed toward methods, apparatuses, assemblies, systems and/or devices related to rainwater catchment and use, which include various processing stages. In one exemplary embodiment, at least one stage is selected from a list of: first flush separation, screening, speed reduction, settlement, disinfection, filtering and/or purification.

In the present application, a container shall mean any receptacle intended to hold within its hollow interior solid (or semi-solid, such as powders or granules) products, liquids or gases.

In one exemplary embodiment, a tight closure diverter container is provided, which includes at least one orifice or inlet at the top for the insertion of a pipe at least substantially leading to one of the pipe ends to a bottom or floor of the diverter container, and additionally connecting and sealing the resulting perimeter between the pipe outer walls and the orifice, wherein a tight closure is made with the use of a sealing ring. Thus, when a liquid is to be delivered to the diverter container, the liquid enters only through the pipe upper end, and the liquid travels by gravity along the pipe until the liquid reaches the pipe lower end where the bottom of the container is located. Thus, when a liquid enters the diverter container, the pipe works both as an inlet pipe and as an air vent because, for every incoming volume of water, the same volume of air exists through the same pipe. In other words, once a liquid such as water enters the diverter container, the water continues to enter and, as waters enters, the same volume of air exists through the same pipe. Once the water level covers the pipe lower end, the air can no longer escape and a saturation level is reached, so the air vent operation is obstructed and additional water is prevented from entering due to the diverter container being tightly closed. In one exemplary embodiment, the pipe length is fitted so that the saturation level is adjusted accordingly, such that the incoming volume of water is defined based on the pipe length and the volumetric capacity of the diverter container. In another exemplary embodiment, the pipe may slide outwardly or inwardly relative to the diverter container, thus adjusting the saturation level accordingly.

In one exemplary embodiment, the pipe has at least one perforation made on the pipe surface, at a preset height corresponding to an incoming volume, such that the pipe perforation provides for an additional air vent. Thus, as water enters, the water will exceed the level defined by the pipe lower end. However, as there is an additional air vent at a known location, water will continue to enter. Therefore, when water reaches the perforation level and thus the saturation level, a water seal will be created that in turn blocks the operation of the additional air vent, such that that water from the outside is prevented from entering by limiting exit of the same volume of air. In other words, the saturation level is reached once the level at which at least one said perforation (or at least the perforation located at the highest position) is reached, such that water can no longer enter. Hence, by knowing the maximum volumetric capacity and dimensions of the diverter container, a correspondence between the perforation location and the incoming water may be established. In one exemplary embodiment, the additional air vent of the inlet pipe has a specific shape and dimensions so as to be able to tightly close the air vent when the volume of rainwater to be diverted is required to be modified.

Thus, the same pipe having at least two functions: as a water or liquid inlet pipe and as an air vent allowing for air to exit out of the diverter container as water enters until the incoming water itself creates a water seal when the water reaches the highest air vent of the inlet pipe.

In one exemplary embodiment, a graded pipe is provided as a reference to make said at least one perforation, wherein each measurement of the graduation corresponds to a previously calculated volume of incoming water.

For example, an inlet pipe is attached to a diverter container substantially parallelepiped rectangular in shape, having a capacity of N liters, and wherein the diverter container comprises a height H. The pipe is made a perforation at a height H/2 corresponding to half the diverter container so that the saturation level is established at said height H/2, such that the number of liters of incoming water will be N/2. One skilled in the art will appreciate that the shape, symmetry axis, dimension and/or manufacturing material of the diverter container and/or pipe may vary without affecting the subject matter of the present invention.

In one exemplary embodiment, a pipe is provided with a plurality of prefabricated perforations at different pipe heights, wherein each perforation is provided with a removable and/or detachable lid, such that at least one of said perforations may be removed, thus modifying the incoming water capacity or volume of the diverter container, and be closed again if the separation volume of first flush is required to be modified.

In one exemplary embodiment, the diverter container includes at least one cavity or gap within the diverter container, located either at the symmetric center of the diverter container shape or at any other place or corner thereof. In one particular embodiment, the cavity has such rounded corners and an anthropomorphic dimension, that an adult's arm may pass through such cavity. One skilled in the art will appreciate that the number, shape and/or dimension of the cavity may vary without affecting the subject matter of the present invention.

In one exemplary embodiment, a rainwater catchment and use system is provided, which includes at least one or a combination of the following stages: first flush separation, screening, turbulence reduction, settlement, chlorination, particle filtration, activated-carbon filtering, and/or purification.

In one exemplary embodiment, the screening stage is defined by a filtering of leaves through a grid placed at the downspout. In another embodiment, screening includes an additional filtering material. The grid being able to be a mesh having a preset straining capacity. In one exemplary embodiment, the screening stage is at least partially exposed to the exterior, that is, the screening stage is not within a corresponding pipe or submerged. In another exemplary embodiment, the screening stage is not at least partially exposed to the exterior, i.e. the screening stage is within a corresponding pipe.

One skilled in the art will appreciate that the order of the system stages may be fixed or may vary in some of the stages without affecting the subject matter of the present invention.

Also, it has been identified that recovered rainwater is stored in a cistern. However, said operation is normally performed by gravity, such that the water in free motion has a speed that varies according to the height, previous path and amount of water. Thus, water in free fall motion impacts on quiet water and/or on the cistern floor, causing turbulence and a temporary suspension of sediments, i.e. water in free fall motion strikes with a plane perpendicular to the flow, thus creating turbulent flows in the cistern. In one exemplary embodiment, a turbulence reducer submerged in a cistern (in at least partially quiet water) is provided. The turbulence reducer receives water at least partially in free fall motion. Thus, the turbulence reducer receives, dampers and delivers water to different directions. Additionally, the turbulence reducer captures some debris and at least partially prevents water from coming into direct contact with the floor and/or sediments in the cistern.

In one exemplary embodiment, the turbulence reducer is comprised by a hollow housing having at least a first orifice at the top and at least a second orifice. The said at least first orifice is located at the top of the turbulence reducer through which water in free fall motion enters by means of or via a pipe. Hence, the dimensions of the pipe and the upper orifice are compatible with, or attached to, each other with the use of mechanical means known in the art, such as a coupling and/or a corresponding reduction/expansion. Below the upper orifice through which water falls, a cone or pyramid is attached to the inner floor of the turbulence reducer, with the cone or pyramid peak at least partially pointing to the geometrical center of the upper orifice. The cone or pyramid comprises an angle of inclination relative to the horizontal or floor of the turbulence reducer, such that the force carried by the water in free fall motion, having a 90-degree angle, is distributed among its components “X”, “Y” and “Z” according to the cone or pyramid angle of inclination. In one exemplary embodiment, the cone or pyramid may be attached to the turbulence reducer floor by means of or via rounded curves. The turbulence reducer further comprises lower peripheral walls directing water according to its angle of inclination relative to the horizontal. In one exemplary embodiment, instead of a cone or pyramid, a semi-ball shape is used. In one exemplary embodiment, the cone or pyramid is a truncated cone or pyramid. In one exemplary embodiment, the outer shape of the turbulence reducer consists of a hollow polyhedron-shaped housing defined by one upper pyramid and one lower pyramid joined together at its base, wherein both pyramids are truncated, thus defining the housing floor and ceiling, wherein water enters the housing through an orifice located at the housing ceiling.

One skilled in the art will note that the term “pipe” means the conduit that operates to convey water or other fluids from one point to another, including curves, straight lines, joints, etc., wherein the conduit may be rigid, flexible and/or made of different materials.

One skilled in the art will appreciate that the materials used for assembly or manufacture of elements of the present invention may vary without affecting the subject matter of the present invention, and that at least one of: PVC, CPVC, copper, high density polyethylene, low density polyethylene, high density polypropylene, low density polypropylene, bituminous elastomer, polyvinyl chloride and/or any combinations thereof may be selected.

Additionally, one skilled in the art will appreciate that the use or not of straight or non-straight joints, such as couplings, nipples, 45° and/or 90° elbow joints, T-connectors, Y-connectors and/or any other joint-reduction-distribution element in a pipe may vary without affecting the subject matter of the present invention.

### BRIEF DESCRIPTION OF THE FIGURES

Some of the measures, dimensions, and/or representations of the elements in the Figures shown below might be exaggerated and/or modified for illustrative purposes. Additionally, for purposes of visualizing the interior of the diverter container, as well as other elements described herein, drawings are shown with a certain level of transparency.

FIG. 1 shows a first flush diverter container in three different positions when interacting with an inlet pipe vertically and tightly inserted into the diverter container.

FIG. 2 shows a diverter container with an adjustable first flush volume according to one embodiment of the present invention, wherein the inlet pipe comprises an additional air vent.

FIG. 3 shows three diverter containers and an expansion, wherein each diverter container comprises an additional air vent or a perforation at different heights for adjusting the volumetric capacity of each diverter container. Also, a detailed view of the perforation in the inlet pipe for defining an adjustable water level is further shown.

FIG. 4 shows an inlet pipe in a horizontal position, wherein the pipe has been graduated so that each degree or measurement corresponds to a specific volume in the diverter container, and wherein the spacing between each graduation may or may not be varied to fit the shape and dimensions of the diverter container to which the inlet pipe is attached according to one embodiment of the present invention.

FIG. 5 shows a diagram of a system for catchment, adjustable diversion, screening, settlement, disinfection and filtering of rainwater according to one embodiment of the present invention.

FIG. 6 shows a plurality of first flush diverter containers modularly connected in parallel using a T-type connection, wherein the diverter containers may or may not have different diversion capacities and may or may not be located at the same height with each other.

FIG. 7 shows a plurality of first flush diverter containers modularly connected in parallel and in series using at least two T-type connections, wherein the diverter containers may or may not have different diversion capacities and may or may not be at the same height with each other.

FIG. 8 shows an enlarged view of a first flush diverter system, wherein the water passes through a pipe and is diverted by a T-type connection attached to the pipe, wherein the T-type connection operating diameter is greater than the pipe operating diameter.

FIG. 9 shows isometric views of two pipe reductions as is customary in the art, wherein one reduction (left side) is of a concentric type and the other two reductions (central and right sides, respectively) are of a downward and upward eccentric type.

FIG. 10 is an exploded diagram of the T-type connection assembly attached to an adjustable first flush diverter container, showing the orientation of the eccentric reductions according to one embodiment of the present invention.

FIG. 11 shows a detailed view of rainwater catchment and use system according to one embodiment of the present invention.

FIG. 12 shows a stage for removing water that is in a settlement stage in a reservoir or cistern, wherein debris at the bottom of the reservoir or cistern are prevented from being directly altered or agitated.

FIG. 13 shows a top (left) view and an enlarged front (right) view of a turbulence reducer having removable or cuttable windows according to one embodiment of the present invention.

FIG. 14 shows a top (left) view and an enlarged cross-section SS front (right) view of a turbulence reducer having removable or cuttable windows according to one embodiment of the present invention, wherein the turbulence reducer includes an inner three-dimensional polygon substantially matching the outer shape of the turbulence reducer for expelling water in a damping manner.

FIG. 15 shows a non-limiting illustrative list of various outer shapes adopted by the turbulence reducer and/or the inner three-dimensional polygon of the turbulence reducer.

FIG. 16 shows a diagram of a diverter system for diverting an adjustable volume of first flush, the diverter system is attached by means of or via a pipe to a leaf filter and a turbulence reducer according to one embodiment of the present invention, wherein a cistern is shown to be located below the diverter system.

FIG. 17 shows a diagram of a diverter system for diverting an adjustable volume of first flush, the diverter system is attached by means of or via a pipe to a leaf filter and a turbulence reducer according to one embodiment of the present invention, wherein a cistern is shown to be located at the same level as the diverter system and a Y-type three-way connection is used. The connections and elements around the exploded leaf filter are further shown.

FIG. 18 shows a diagram of a first flush diverter system comprised by two diverter containers connected in a configuration in parallel according to another embodiment, wherein the configuration in parallel is carried out by means of or via water outlets located at the lower side thereof. The Y-type three-way connector attached to the system is further shown.

### DETAILED DESCRIPTION OF VARIOUS EMBODIMENTS

The following description is provided to enable those skilled in the art to perform and use the embodiments, and said description is provided within the context of a particular application and the requirements thereof. Various modifications to the embodiments disclosed herein will become easily evident to those skilled in the art and the general principles defined herein may be applied to other embodiments and applications without departing from the spirit and scope of the present disclosure. Therefore, the present invention is not limited to the embodiments shown, but on the contrary, the present invention must conform to the widest scope consistent with the principles and characteristics disclosed herein. The term “first flush diverter or separator” means the device, system or apparatus identifying the first flush, separating the first flush from the remainder of a rainfall event and directing the first flush to a specific direction, reservoir or container. Moreover, the terms “diverter” and “separator” are used interchangeably herein.

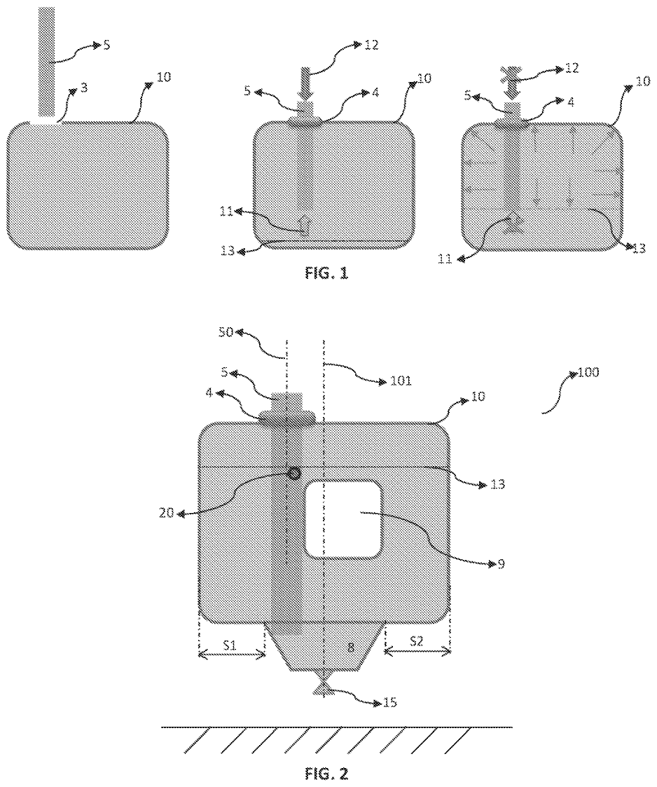

FIG. 1 shows a diverter container 10 according to one embodiment of the present invention in three different positions from left to right. The front face of diverter container 10 is assumed to be at least partially transparent to allow for visualization of the interior thereof. In the first position, a tightly closed diverter container 10 with a volumetric capacity predetermined from its design and manufacture is illustrated, which includes at least one perforation 3 on the upper surface or roof of the diverter container 10. Said at least one perforation 3 being of sufficient size so that a pipe 5 may be inserted and/or attached inside the diverter container 10. In the second position, the diverter container 10 is shown as having been at least partially vertically inserted pipe 5, and the joining portion between the pipe and the diverter container is sealed with a mechanical seal 4 known in the art, such as a sealing ring and/or a gasket. In one exemplary embodiment, the sealing ring being defined by an elastomeric liner ring and at least one sealing lip. With this configuration, the incoming liquid 12 enters the diverter container 10 to be deposited by gravity at the bottom thereof. As water level 13 rises, the outcoming air 11 exits through the same pipe 5, such that the pipe works both as a liquid inlet and as an air vent. In the third position, the water level 13 is shown to have reached the lower end of pipe 5 through which air was being expelled. Therefore, once the water reaches said level, a seal is created and said water seal prevents air from flowing out and additional water from entering, thus defining a saturation point corresponding to a volume of incoming water defined by the level at which the air vent is shut-off (the lower end of pipe 5 in this case). In one particular embodiment of the present invention, the sealing ring 4 further fixes the inlet pipe 5 in place.

In one embodiment of the present invention, the tight sealing means 4 for sealing the pipe to the diverter container 10 allow for upward or downward sliding of the pipe without the pipe losing its tightness. Hence, one skilled in the art will appreciate that the approach used for tightly sealing the joining between the pipe outer surface 5 and orifice 3 may vary without affecting the subject matter of the present invention, and that at least one of a sealing ring, gasket, nipple and/or any combinations thereof may be used, wherein a lubricant may be applied in order to facilitate sliding of pipe 5. In one exemplary embodiment, said at least one perforation 3 is made after the diverter container 10 has been manufactured. In one embodiment of the present invention, said at least one perforation 3 is included in the original manufacturing design of the diverter container 10, that is, the diverter container 10 already includes a perforation 3 in its design and manufacturing.

In another exemplary embodiment, at least one seal 4 used to join and tightly seal the pipe-diverter container joint is selected from a list of: a corresponding screw/nut relationship between the pipe and the diverter container, a press-on gasket, a sealing adhesive and/or a removable lid.

FIG. 2 shows a diverter container 10 according to one embodiment of the present invention, wherein said diverter container 10 comprises at least one pipe 5 for entry of water by gravity, such that the interior of said diverter container 10 may only have access to the exterior through said at least one pipe 5; a tight seal 4 for each inlet pipe 5; and at least one drain valve 15 through which diverter container 10 is purged. In one particular exemplary embodiment, the diverter container 10 comprises: at least one cavity 9 for providing structural strength, at least one conical shape 8 at the central lower side of the diverter container 10 for accumulating and facilitating purge of the diverter container 10 through the drain valve 15. In one embodiment of the present invention, the lower end of pipe 5 reaches the conical shape 8. In one embodiment of the present invention, the dimensions of the conical shape 8 are such that at least two straight surfaces S1 and S2 may be incorporated in the lower side of the diverter container 10. In one exemplary embodiment, the length of S1 and S2 is at least 10 cm. In one particular embodiment, the length of S1 and S2 ranges between 20 and 30 cm. In one exemplary embodiment the diverter container 10 has such a thickness so as to allow for surfaces S1 and/or S2 to operate as a support and fixation thereof. Drain valve 15 being a valve that allows for fully opening, fully closing and/or partially closing of the valve, wherein intentional dripping is allowed in order to gradually empty the diverter container until the next rainfall event. Furthermore, one skilled in the art will appreciate that the location, amount, capacity, dimensions and shape of drain valve 15 may vary without affecting the present invention, and that two or more valves may be incorporated at different places of the diverter container, such as the lower side, the front side, the left side, the right side the rear side, and/any combinations thereof. Moreover, FIG. 2 shows an additional air vent 20 defined by a perforation made at a preset height on pipe 5, wherein said height corresponds to an amount of water lower than the diverter container maximum volumetric capacity, that is, a perforation that modifies the saturation point of diverter container 10, thus allowing for adjustment of the water capacity that said diverter container 10 may divert.

In one exemplary embodiment, cavity 9 is located above the geometrical center of diverter container 10, wherein axis 101 passes through said geometrical center. In one exemplary embodiment, cavity 9 is not located above the geometrical center of diverter container 10. In one exemplary embodiment, the geometrical center of cavity 9 matches the geometrical center of diverter container 10. In another embodiment of the present invention, the geometrical center of cavity 9 does not match the geometrical center of diverter container 10.

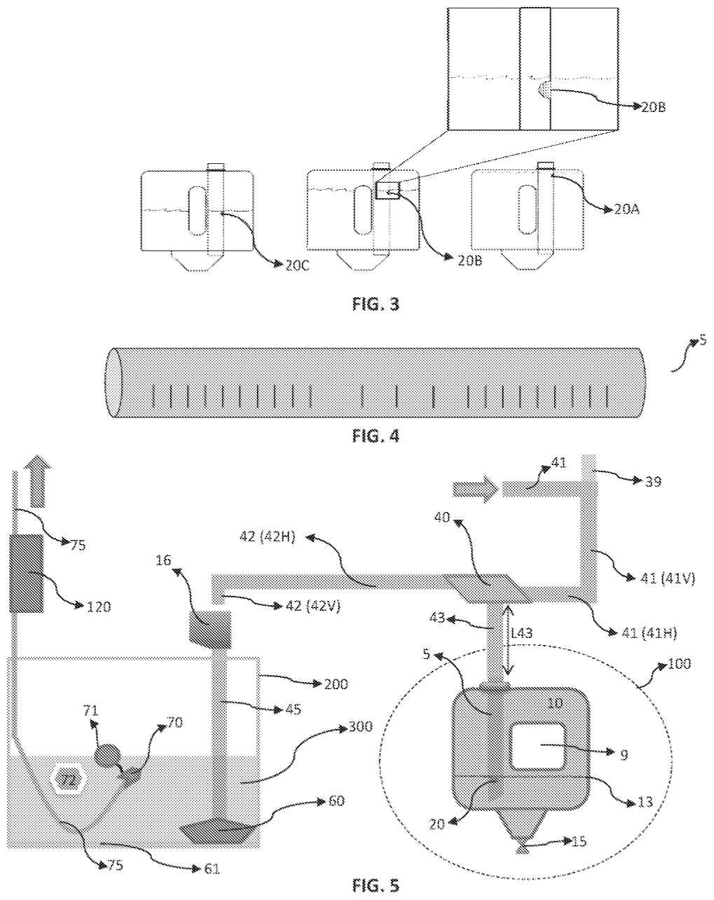

FIG. 3 shows a diagram of three diverter containers already having attached an inlet pipe according to one exemplary embodiment, wherein a perforation has been made at different heights 20A, 20B and 20C, such that each of said perforations represents an additional air vent which, when an saturation level is reached and the water covers said additional air vent, shuts off the exit of air and an incoming volume of water is fixed relative to the perforation height, thereby adjusting the volume of water diverted in each diverter container. One skilled in the art will appreciate that the approach used to make the perforations on the inlet pipe may vary without affecting the subject matter of the present invention. Furthermore, one skilled in the art will appreciate that the shape and/or dimensions of the perforation on the inlet pipe may vary (to a certain extent that does not modify the volume of water diverted) without affecting the subject matter of the present invention.

FIG. 4 shows a perspective view of a pipe 5 in a horizontal position, wherein pipe 5 has been graduated. Each graduation measurement corresponds to a specific volume, such that, when making a perforation at a corresponding graduation measurement, the perforation will work as an additional air vent, thereby allowing for the entry of fluid up to that graduation measurement, that is, up to the specified volume, by adjusting the diverter container capacity at user's convenience. Moreover, in the event of modifications to the property where rainwater is caught, or changes in the dimensions of the rooftop (and thus in the first flush calculation), orifice 20 may be tightly covered and a new orifice may be made based on the new calculations and/or a newly replaced pipe 5 may be used.

In an exemplary embodiment, diverter container 10 has a maximum volumetric capacity of 200±20 liters. In an embodiment of the present invention, diverter container 10 has a maximum volumetric capacity of 40±5 liters. However, one skilled in the art will appreciate that the volumetric capacity of diverter container 10 may vary without affecting the subject matter of the present invention. One skilled in the art will further appreciate that the way of graduating the volume of water diverted in diverter container 10, including or not cavity 9, may vary without affecting the subject matter of the present invention.

FIG. 5 shows a diagram of a system 1 for use of rainwater accumulated on a roof-like surface that is then channeled through a main pipe into a cistern. For illustrative purposes, the main pipe is divided into different sections depending on the pipe function. System 1 comprises a stage of first flush separation/diversion according to one embodiment of the present invention, wherein a cistern 200 is located at the same level as the first flush diverter 100. Thus, it can be observed: at least a downspout or pipe 41 that comes from a catchment surface, such as a rooftop, through which accumulated rainwater is channeled, said pipe 41 comprising at least one vertical inlet pipe section 41V and/or at least one horizontal inlet pipe section 41H; at least one general air vent 39; at least one leaf filter 16 defining a screening stage at which large solid waste is separated from the channeled rainwater; at least one first flush diverter system 100 comprising a diverter container 10 with a preset volumetric capacity; at least one outlet pipe 42 which may comprise at least one horizontal section 42H and/or at least one vertical section 42V for discharging water by gravity to screening stage 16 and then to cistern 200 through water drop pipe 45; at least one three-way connector 40 (a T-type three-way connector is shown in this case), such that a first outlet or connection of the three-way connector is for inlet pipe 41; a second outlet or connection of the three-way connector is to be attached to outlet pipe 42; and an at least partially downwardly pointing third outlet or connection of the three-way connector is for said at least one first flush diverter system 100, wherein said connection is carried out by means of or via a pipe section 43 (said third connection pointing downwardly so that water tends to fall by gravity through pipe section 43); at least one turbulence reducer 60 attached to the end of the water drop pipe 45, which reaches the reservoir or cistern 200, preventing water flow from touching floor 61, wherein the recovered rainwater entering a settlement stage will be stored; at least one check valve 70 attached to a float 71, such that the check valve is raised at a preset distance from the water surface; at least one disinfection stage 72 comprising at least one chemical dispenser in the water stored 300 in a cistern 200 and/or in an additional reservoir 90 (not shown in the figures); at least one riser pipe 75 connecting the cistern to at least one additional tank or reservoir 90 (not shown in the figures), wherein water will be channeled for domestic use; at least one filtering stage 120 attached to the riser pipe 75. In one exemplary embodiment, the filtering stage 120 is defined by a filtering train comprised by at least one sediment filter (not shown in FIG. 5) and at least one activated-carbon filter (not shown in FIG. 5) for removal of fine contaminants, as well as odors and tastes. Additionally, it is shown a perforation 20 located at a preset height from pipe 5 and corresponding to a first flush separation volume defined by level line 13. In one exemplary embodiment, the check valve 70 comprises a fine-meshed fabric made of chromium steel 1.4306 or equivalent. One skilled in the art will appreciate that the use of a three-way connector may apply for a T-connector and for a Y-connector or any variations thereof, without affecting the subject matter. Moreover, the order of the first, second and third outlets of each three-way connector may vary, provided that at least one of such outlets is an at least partially downwardly pointing outlet.

In one exemplary embodiment, the disinfection stage 72 takes place at the cistern 200, the pipe 75 (before and/or after the filtration stage 120) and/or the additional reservoir 90. The disinfection stage 72 further includes at least one from the list of: chlorination, ozone and/or silver (these techniques are already known in art). Moreover, pipe 43 is shown as having been attached to the third downwardly pointing outlet of the three-way connection 40. Hence, length L43 of pipe 43 may be adjusted, thereby also adjusting connector 40 height, either making it smaller or longer. In this way, the cistern may be located at the same height, or below or even above the diverter container 100, provided that the three-way connector 40 is located above the cistern 200 and above the diverter container 100, and that the falling of water by gravity is not affected. Moreover, in one embodiment, a check valve is attached to pipe 43. In one particular embodiment, a check valve is attached to the third at least partially downwardly pointing outlet of the three-way connection, wherein said three-way connection is a T-type three-way connection or a Y-type three-way connection.

In one particular embodiment, the sediment filter filters particles of 50 micra in size. One skilled in the art will appreciate that the filtering capacity of the sediment filter may vary without affecting the subject matter of the present invention.

In one exemplary embodiment, the screening stage is at least partially exposed to the exterior, that is, the screening stage is not within a corresponding pipe or submerged. In one particular embodiment, the screening stage is within the cistern, a manhole, a pipe section or somewhere else in the system.

The turbulence reducer 60 allowing water from pipe 45 to smoothly entering cistern 200 so that water does not make contact with floor 61 and does not lift the sediment accumulated on the cistern lowest part on which sediment tends to be placed by gravity. The float 71 having such dimensions, floating capacity and attachment to check valve 70, so as to allow for check valve 70 to be located at a preset distance below the water surface. In one exemplary embodiment, said preset distance is between 5 and ±5 cm. In one exemplary embodiment, the disinfection stage 72 includes a chemical dispenser. In one particular embodiment, the chemical dispenser dispenses chlorine. One skilled in the art will appreciate that the chemicals dispensed into the recovered rainwater may vary without affecting the matter of the present invention and may be applied at different stages and/or parts of the system.

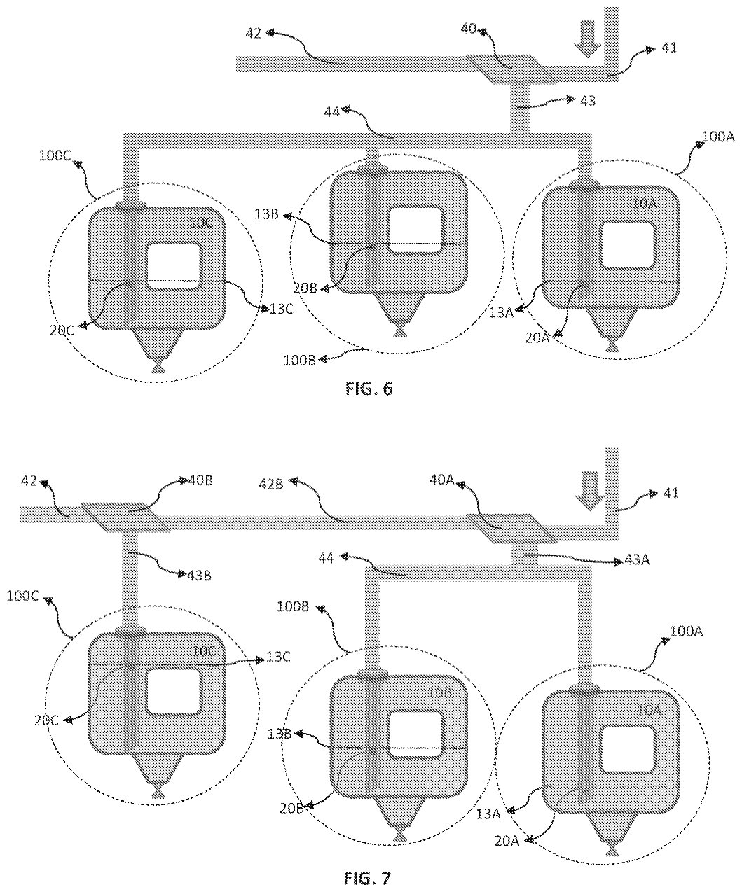

FIG. 6 shows a segment of system 1 according to one embodiment of the present invention, wherein three first flush diverter or separator systems 100A, 100B and 100C have been modularly attached to each other, wherein said first flush diverters are connected to each other in a configuration in parallel. It is further shown how each first flush diverter 100A, 100B, 100C has a perforation 20A, 20B and 20C at a different height 5A, 5B and 5C, respectively, from the pipe, such that each first flush diverter 100A, 100B, 100C will divert different amounts of water. In one exemplary embodiment, perforations 20A, 20B, 20C of each first flush diverter 100A, 100B, 100C are located at the same height, such that each first flush diverter 100A, 100B, 100C separates the same amount of first flush. Thus, when the recovered rainwater is channeled through inlet pipe 41, rainwater falls by gravity into a three-way connector 40 through pipe 43, thereby reaching first flush diverters 100A, 100B, 100C through a secondary delivery pipe or branch 44. As said connection is configured in parallel, once the three first flush diverters 100A, 100B, 100C are full with the volume of first flush previously calculated for each first flush diverter, water will saturate pipe 43 up to the pipe edge, such that the overflow will now move through the outlet pipe 42.

FIG. 7 shows a segment of system 1 according to one embodiment of the present invention, wherein three first flush diverter or separator systems 100A, 100B and 100C have been modularly attached to each other, wherein first flush diverter systems 100A and 100B have a configuration in parallel, and a configuration in series relative to first flush diverter system 100C. Thus, it is further shown an inlet pipe 41 conveying the channeled rainwater, wherein rainwater enters a first three-way connector 40A, such that rainwater falls by gravity through the third downwardly pointing outlet of the three-way connector 40A where pipe 43A is located, said pipe 43A being connected to a secondary delivery pipe or branch 44 for delivery of rainwater to first flush diverters 100A and 100B. Once said first flush diverter systems 100A and 100B reach a saturation point defined, respectively, by perforation 20A and 20B, pipe 43 will also be saturated, so the overflow will continue moving through pipe 42B, said pipe 42B running up to a second three-way connector 40B to which first flush diverter system 100C is connected, said first flush diverter system 100C operating up to a saturation point defined by the location of perforation 20C in pipe 5 of said first flush diverter 100C. One skilled in the art will appreciate that the capacity and number of T-type or Y-type three-way connectors, as well as the number of first flush diverter systems connected to each other in series and/or in parallel by means of or via three-way connectors may vary without affecting the subject matter of the present invention. Therefore, when it comes to a connection in series of two or more first flush diverter systems, the first outlet of a subsequent three-way connection is connected to the second outlet of a previous three-way connection, such that the third at least partially downwardly pointing outlet in each three-way connection is attached to the upper end of the corresponding pipe of at least one diverter container. In another exemplary embodiment, the configuration in series is also performed by directly connecting the water outlet of at least one first diverter container to the inlet pipe of at least one second or subsequent diverter container, wherein the second or subsequent diverter container is below the previous diverter container, that is, one below the other, with the outlet of one diverter container being connected to the inlet of the other diverter container, and so on for N diverter containers. Thus, two ways of connection in series are defined, one connection through a three-way connection and another connection by directly connecting the outlet of one diverter container to the inlet of the other diverter container.

One skilled in the art will appreciate that the maximum volumetric capacity of a diverter container may vary with respect to one or more diverter containers connected in series and/or in parallel to the same system without affecting the subject matter of the present invention.

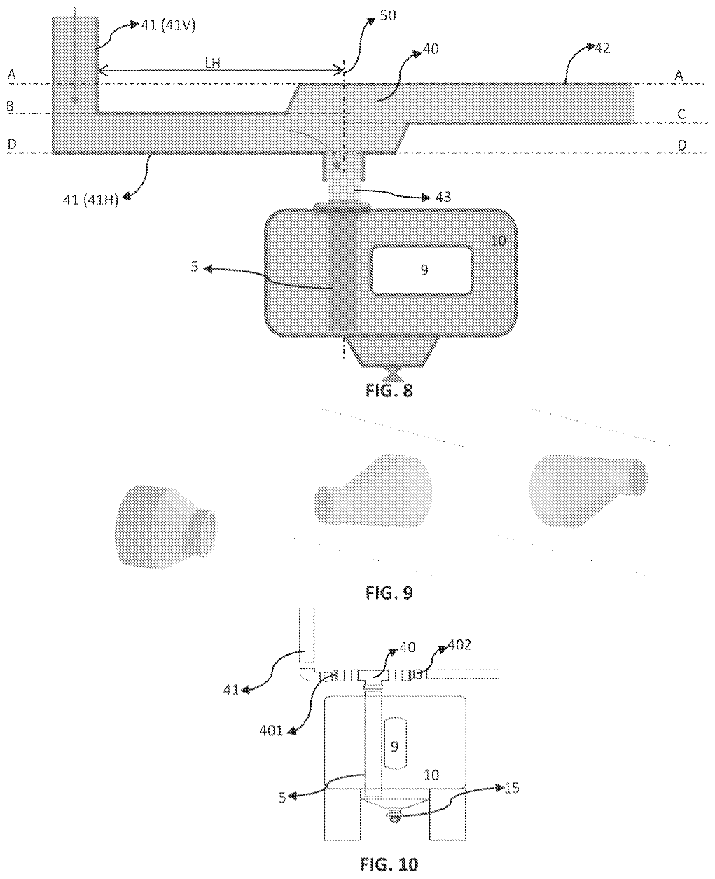

FIG. 8 is an enlarged view of three-way connector 40, showing the inlet pipe 41 with an operating diameter defined by distance BD. The outlet pipe 42 with an operating diameter AC It is further shown. Inlet pipe 41 and outlet pipe 42 are attached, respectively, to the first and second outlets of three-way connector 40, wherein three-way connector 40 has a diameter or working area defined by distance AD. In one exemplary embodiment, the operating diameter of the three-way connector is greater than the operating diameter of inlet pipe 42 and/or the operating diameter of outlet pipe 42, such that the way of connecting pipe 41 to the three-way connector is by means of or via an expansion, and the way of connecting the three-way connector to outlet pipe 42 is by means of or via a reduction. One skilled in the art will appreciate that the term reduction and/or expansion is used for illustrative purposes, since the use of said terms will depend on the different standpoints as the element used for this function is commonly known as “reducer”, regardless of whether its function is to expand or to reduce.

Additionally, a separating distance of axis 50 from pipe 5 is shown, said pipe 5 is separated a distance LH relative to a vertical inlet pipe section 41V. In one exemplary embodiment, said distance LH is substantially 0, such that said vertical inlet pipe 41V falls directly into pipe 5. Hence, a check valve is attached to the third at least partially downwardly pointing outlet of the three-way connector and/or any other section of pipe 43.

FIG. 9 shows a perspective view of two models for reducing PVC or other plastics, such as polypropylene already known in art. One type of reduction (left) where the inlet and the outlet are concentric with each other, and another type of reduction where the inlet and the outlet are not concentric with each other and the inlet and outlet may be pointing downwardly (middle) or upwardly (right). Non-concentric reduction is commonly called eccentric reduction. Moreover, one skilled in the art will appreciate that a three-way connection already including a reduction may be used in any of its outlets without affecting the subject matter of the present invention.

FIG. 10 shows an exploded view of the assembly around the T-type three-way connector 40 with an inlet pipe and an outlet pipe according to one embodiment of the present invention. The operating diameter of the T-type three-way connector 40 being greater than the operating diameter of the inlet pipe 41 and the outlet pipe 42. Thus, the way of performing a connection is by means of or via a reduction 401 and a reduction 402. Hence, the operating axis 410 of inlet pipe 41, and the operating axis 420 of outlet pipe 42 are shown, wherein said reductions are attached to each other in such a way that axes 410 and 420 are parallel, but not co-linear, that is, one reduction 402 is pointing upwardly and the other reduction 401 is pointing downwardly. In another embodiment, both reductions 401 and 402 are pointing upwardly. In one exemplary embodiment the operating diameter of the T-type three-way connector is at least one scale greater than the operating diameter of inlet pipe 41 and/or outlet pipe 42.

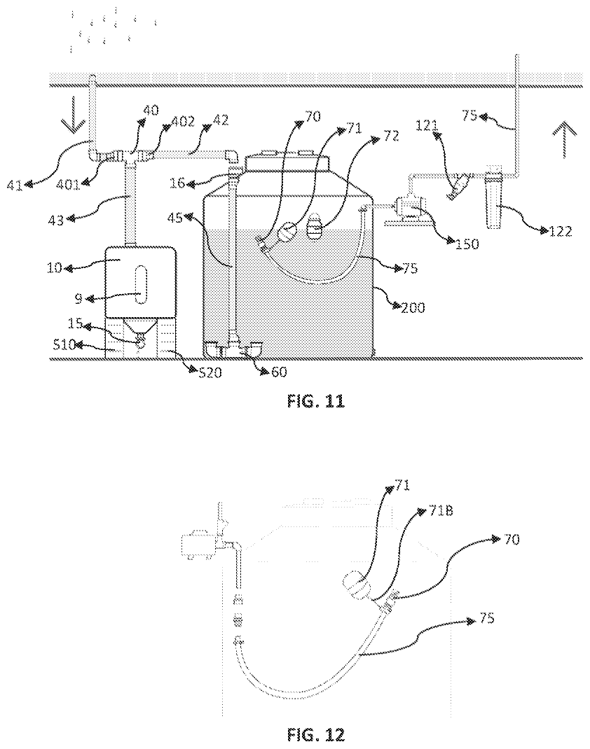

FIG. 11 shows a detailed view of a system 1 for the use of rainwater according to one embodiment of the present invention. Thus, it is illustrated how water is channeled through an inlet pipe so that a volume of first flush is diverted, separated and/or channeled by the T-type three-way connector 40 into first flush diverter system 100 and, once it is full based on previous calculations, the overflow is passed through a screening stage by means of or via a meshed grid or leaf separator 16. One skilled in the art will appreciate that the mesh features to perform the screening stage may vary without affecting the subject matter of the present invention. The water then falls by gravity into the container or cistern 200 through pipe 45. Thus, a turbulence reducer 60 is located at the end of pipe 45, said turbulence reducer 60 decomposes the force of water falling by gravity, so that said force is split into different components in “X”, “Y” and “Z”, thereby reducing the direct impact force of 90 degrees on the horizontal and also preventing incoming water from making direct contact with the cistern floor 200, thus favoring the settlement stage. Moreover, a float 71 is shown as being attached to check valve 70, such that the stored water is removed through hose 75 (by pumping with a pump 150). Additionally, it can be observed how direct removal of water is carried out without directly touching the cistern floor 200, thus avoiding the removal of sediments.

In one exemplary embodiment, the turbulence reducer 60 is located on the cistern floor 200. In another exemplary embodiment, the turbulence reducer 60 is located above the cistern floor 200.

One skilled in the art will appreciate that the term pipe may refer to the joining of rigid or flexible pipes, connectors and/or any combination thereof to channel a fluid from one point to another.

FIG. 12, shows an enlarged view of check valve 70 attached to a float 71 by means of a hook 71B. Thus, it can be observed how the configuration of float 71 with hook 71B allows for adjustment of the depth at which check valve 70 will be located relative to the water surface. In one exemplary embodiment, the hook 71B and/or the float 71 has such a configuration that the depth from which water is removed through check valve 70 is 15±5 cm.

FIG. 13 shows an upper (left) view and an enlarged front (right) view of a turbulence reducer 60 according to one embodiment of the present invention, wherein said at least one turbulence reducer is located at the bottom of a cistern where water is substantially quiet. Thus, it can be observed that pipe 45 is attached to the upper part of said turbulence reducer 60 to allow for entry of the caught rainwater in free fall motion, the flow of which may vary depending on the system and/or the type of rainfall event. From a top view, it can be observed that turbulence reducer 60 comprises a substantially rectangular-shaped outer polygon, and at least one window 61F, 61L and 61R, respectively, on its front face, left-side face and right-side face, through which water from pipe 45 will exit, at least partially keeping a trajectory depending on the design of the turbulence reducer 60. In this exemplary embodiment, the back face 61B does not comprise a window; however, the turbulence reducer 60 comprises a mark so that said window 61B may be made in the future, in case that the turbulence reducer 60 is required to operate at a greater discharging flow as a result of water coming from pipe 45. Additionally, other windows may be kept closed, if required, either for flow control and/or flow channeling, as water coming out from the turbulence reducer 60 is desired to be given a certain direction and/or to be directed to a specific location in cistern 200. In one exemplary embodiment, the area of at least one window 61F, 61L, 61R and/or 61B is greater than the cross-sectional area of pipe 45 through which the recovered rainwater enters.

FIG. 14 depicts a top (left) view and an enlarged cross-section SS front (right) view, showing the interior of the turbulence reducer 60 according to one embodiment of the present invention, wherein water falls by gravity through pipe 45, and wherein the longitudinal axis K of pipe 45 is at the geometrical center (from a top view) of turbulence reducer 60. The top view shows the contour or outer shape defining the outer polygon of turbulence reducer 60, said outer polygon consisting, in this example, of a substantially rectangular-shaped outer polygon with rounded corners. In one exemplary embodiment, said contour is triangular in shape.

The axis K defining the direction of the water flow in free fall motion, so that the water flow enters into the turbulence reducer 60 through its upper side, and once the water is inside the turbulence reducer 60, the water is directed and delivered along the horizontal plane by means of or via a pyramid 62 whose footprint covers the entire cross-sectional area of pipe 45, a truncated pyramid is shown in this example. Thus, when the water falls, the water hits the pyramid and, depending on the degree of inclination of said pyramid 62, defined by angles Q3 and Q4, the force of the falling water is split into components “X” (the horizontal or floor) and “Y” (line K) And “Z” (not shown in this view). Hence, the component “X” pushes the water towards the zone of angle Q2 and/or Q5 and then through window 61L and/or 61R, that is, the water in free fall motion does not have a direct impact on the turbulence reducer floor; instead, the water is channeled by at least two damping angles Q2 and Q3, or Q4 and Q5 greater than 90°, to allow for exit of water through windows 61L and/or 61R, whose angles of inclination Q1 and Q6, respectively, are substantially the same as angles Q3 and Q5, respectively. One skilled in the art will appreciate that the dimensions and/or configuration of pyramid 62 may vary without affecting the subject matter of the present invention. In one exemplary embodiment, the contour or outer shape of the turbulence reducer 60 matches the type of pyramid 60, that is, if the outer polygon of the turbulence reducer 60 is a rectangle or substantially a rectangle, the pyramid 62 will be a rectangular pyramid, such that the faces or sides of the pyramid point to the corresponding faces or sides of the outer polygon of the turbulence reducer 60. Similarly, according to this exemplary embodiment if the outer polygon of the turbulence reducer 60 is a triangle, the pyramid 62 will be a triangular pyramid. One skilled in the art will appreciate that the contour or outer shape (from a top view) of the turbulence reducer 60 may vary, increasing from at least three sides (triangle), without affecting the subject matter of the present invention.

One skilled in the art will appreciate that pyramid 62 may be an additional element forming part of the same turbulence reducer 60 (by projecting the floor of the same turbulence reducer 60), a solid body, a hollow body and/or any combination thereof, without affecting the subject matter of the present invention. One skilled in the art will further appreciate that the method of manufacture of these shapes may vary and/or may include physical/technological limitations without affecting the subject matter of the present invention. Furthermore, one skilled in the art will appreciate that attachment of pipe 45 to the turbulence reducer 60 may be carried out with the use of a coupling, nipple, reduction, expansion and/or any combination thereof.

The purpose of the turbulence reducer 60 is to split the force of the water in free fall motion (axis X) into three components in “X”, “Y” and “Z”, depending on the inclination of the inner pyramid 62, so that said components are further channeled according to the shape of the turbulence reducer 60. In another exemplary embodiment, axis K is not above the geometrical center of the turbulence reducer 60. Additionally, in one exemplary embodiment, the outer/lower polygon is an irregular polygon.

In another exemplary embodiment, the outer polygon of the turbulence reducer 60 does not match the type of inner pyramid 62 of the turbulence reducer 60. In one exemplary embodiment, the inner pyramid 62 has more faces or sides than the contour or outer shape of the turbulence reducer 60. In one exemplary embodiment, the inner pyramid 62 has fewer faces or sides than the outer polygon of the turbulence reducer 60.

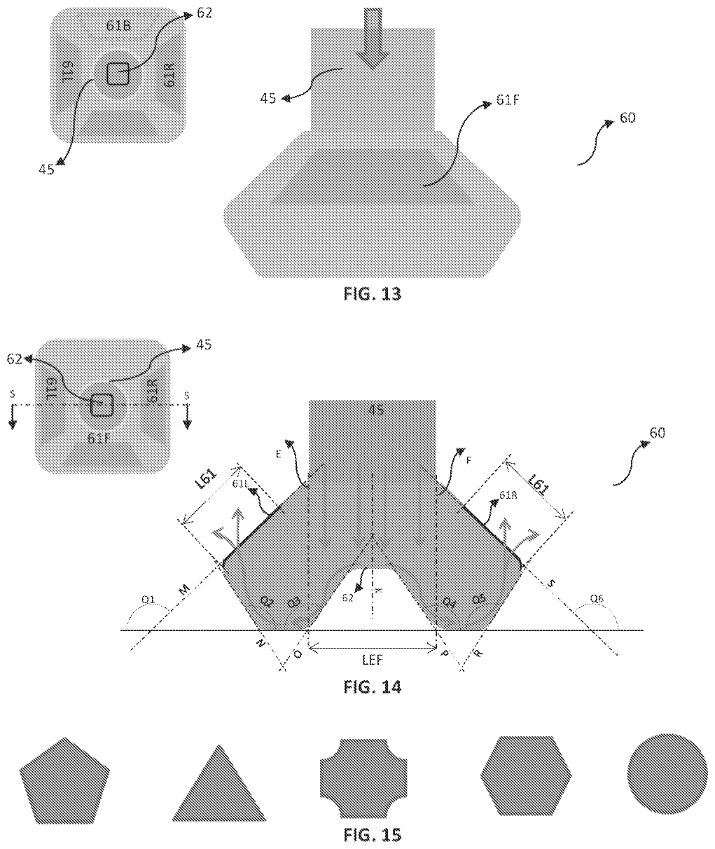

FIG. 15 shows a top view of the various outer shapes that the turbulence reducer 60 and the inner pyramid 62 may adopt. In one exemplary embodiment, the housing or outer shape of the turbulence reducer 60 is comprised by a hollow polyhedron-shaped body defined by the joining of two pyramids (of any type, as shown in FIG. 14) by its base, wherein at least one pyramid may or may not be truncated. In one particular embodiment, at least one edge and/or corner of the turbulence reducer 60 is rounded by a preset radius depending on the characteristics of the flow in free fall motion. Furthermore, in one exemplary embodiment, the inner pyramid 62 is aligned and is of the same type as the two pyramids forming said polyhedron.

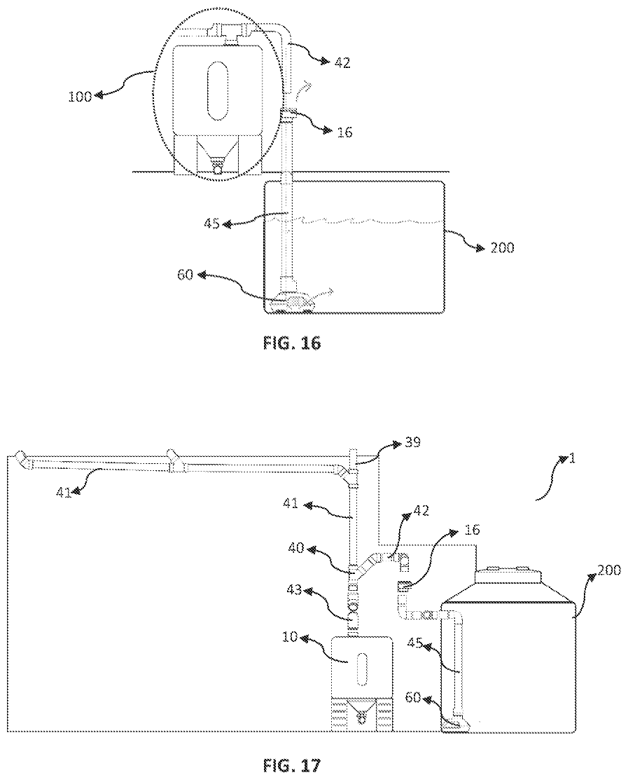

FIG. 16 shows a diagram of a first flush diverter system 100 connected to a screening stage 16 and then connected to a turbulence reducer 60 located inside a cistern 200.

FIG. 17 shows a diagram of a partial system 1 for the use of rainwater according to one exemplary embodiment, wherein a Y-type three-way connection 40 is attached. Thus, it can be observed how water is channeled by pipe 41 through connections to the rooftop and an air vent 39, such that the water reaches by gravity the three-way connection 40. Once the water reaches said three-way connection 40, the water falls directly into the diverter container 10 and, once said diverter container 10 reaches a preset saturation point, the water ceases to enter pipe 43, such that the overflow will now be directed through pipe 42, passing through the screening stage 42 and then to the turbulence reducer 60, running through the vertical pipe 45, wherein the water is stored in the cistern 200.

One skilled in the art will appreciate that the orientation and/or degrees of inclination of the three-way connection 40, whether it is a T-type connection or a Y-type connection, may vary without affecting the subject matter of the present invention.

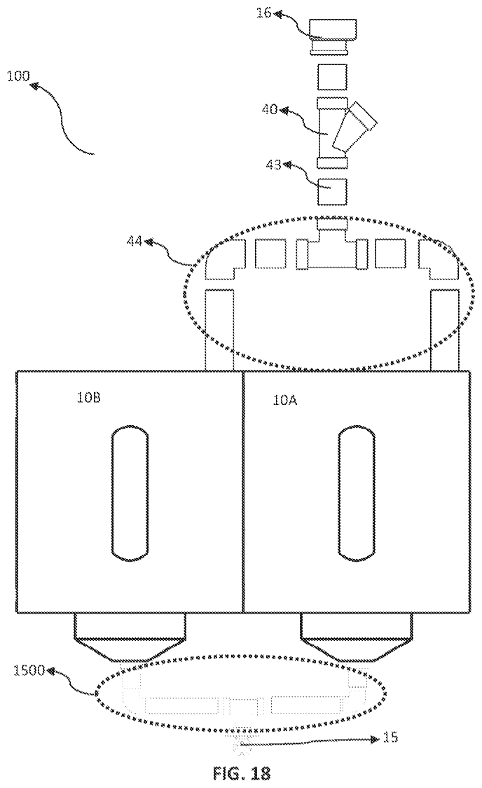

FIG. 18 shows a diagram of a first flush diverter system 100 comprised by two diverter containers 10A and 10B arranged in a configuration in parallel according to one exemplary embodiment, wherein the configuration in parallel is first obtained by the connection, at the bottom, of the diverter containers 10A and 10B via a secondary drainage pipe 1500 (shown in an exploded view) connecting the water outlet of diverter container 10A to the water outlet of diverter container 10B. Also, the parallel connection is obtained with the use of an additional pipe 44 (shown in an exploded view) connected to pipe 43, said pipe 43 is in turn connected to the third at least partially downwardly pointing outlet of the three-way connection 40. Thus, at least one outlet valve 15 is attached to said secondary drainage pipe 1500 at the lower part of the diverter containers to empty the system. In another embodiment, at least one additional water valve (not shown in the figures) is located at the bottom of the front and/or side face of at least one diverter container for separately channeling the caught water. Also, it can be observed how pipes 41 and 42 are vertical, such that the three-way connection 40 (a Y-type three-way connection in this case) is turned and faced according to the present invention and/or the cistern location.

In one exemplary embodiment, in a system with M diverter containers 10 (wherein M is greater than 2), the number of perforations 20 is at least M−1.

Moreover, it can be observed how the screening stage 16 defined by a grid with a preset straining capacity is located before the first flush diversion stage. Thus, one skilled in the art will appreciate that the stages undergone by the rainwater for use thereof may vary in number and/or location in a rainwater use system without affecting the subject matter of the present invention.

Thus, in one exemplary embodiment, a system for diverting an adjustable amount of water is claimed, wherein rainwater runs through a main pipe, the system comprising: at least one closed diverter container, wherein said diverter container has a maximum height and volumetric capacity, a lower part of said diverter container comprises at least one water outlet valve, and an upper part of said diverter container comprises at least one water inlet defined by an orifice having a preset area and shape on the diverter container surface; one pipe per diverter container, said pipe including a length at least partially similar to the height of the diverter container, and including an area and shape substantially equal to that of the water inlet orifice where the pipe is vertically inserted, such that the pipe is tightly attached to the diverter container, with the pipe lower end remaining inside and at the lower part of the diverter container, and with the pipe upper end remaining at least at level with the diverter container upper surface; and at least one three-way connection, wherein the first and second outlets of said at least one three-way connection are attached to the main pipe through which water flows in the direction from the first outlet to the second outlet, such that the third outlet of said at least one three-way connection is pointing downwardly and is attached to the upper end of the corresponding pipe of said at least one diverter container; wherein the three-way connection is located above said at least one diverter container. Wherein the operating diameter of the T-type connection is greater than the operating diameter of the main pipe; and wherein the pipe section inside the corresponding diverter container comprises a perforation made at a preset height, wherein said height corresponds to a preset volume of water to be diverted.

Also, in one exemplary embodiment, a system for the use of rainwater is claimed, the system comprising: at least one main downspout for channeling the rainwater accumulated on a roof-like surface into a cistern; at least one closed diverter container, wherein said diverter container has a maximum height and volumetric capacity, a lower part of said diverter container comprises at least one water outlet valve, and an upper part of said diverter container comprises at least one water inlet, wherein the volume of water to be diverted by said at least one diverter container is adjusted to the area of the roof-like surface; at least one three-way connection, wherein the first and second outlets of said at least one three-way connection are attached to the main pipe through which water flows in the direction from the first outlet to the second outlet, such that the third at least partially pointing downwardly outlet of the three-way connection is attached to the water inlet of said at least one diverter container, and wherein the three-way connection is above the cistern and above any diverter container attached to said three-way connection; at least one leaf filter attached to the main pipe; at least one turbulence reducer attached to the end of the main pipe, inside the cistern; at least one check valve attached to a main riser pipe for removal of water from the cistern and delivery to an additional reservoir, wherein said check valve comprises a float; at least one particle filter attached to the main riser pipe; at least one activated-carbon filter attached to the main riser pipe; and at least one chemical dispenser attached to the cistern and/or the additional reservoir. Wherein the diverter container is either below, at the same level with, or above the cistern, and wherein the operating diameter of said at least one of three-way connection is greater than the operating diameter of the main downspout; wherein the float is attached to the check valve by means of or via a junction allowing for the valve to be kept within 15±5 cm from the water surface; wherein the third downwardly pointing outlet of the three-way connection is attached to the water inlet of at least two diverter containers by means of or via a secondary pipe; wherein the first and second outlets of said at least one three-way connection are attached to the main pipe by means of or via eccentric reductions; and/or wherein the eccentric reduction of the second outlet of said at least one three-way connection is pointing upwardly.

In one exemplary embodiment, the three-way connection is a T-type three-way connection or a Y-type three-way connection.

Hence, in one exemplary embodiment, a method for using the rainwater accumulated on a roof-like surface is claimed, said method comprising: diverting a preset volume of first flush from a main pipe where the rainwater accumulated on a roof-like surface has been channeled; screening the water in the main pipe that was not diverted to be discharged into a cistern; preventing the discharged water from coming into direct contact with the cistern floor by using a turbulence reducer; removing the water in the cistern from about 15 cm below the water surface; filtering the removed water for sediments, wherein the sediments have a size of at least 50 microns; and activated-carbon filtering the water that has been filtered for sediments.

In another exemplary embodiment, a system for the use of rainwater accumulated on a roof-like surface is claimed, said method comprising: means for diverting a preset volume of first flush from a main pipe where the rainwater accumulated on a roof-like surface has been channeled; means for screening the water in the main pipe that was not diverted to be discharged into a cistern; means for preventing the discharged water from coming into direct contact with the cistern floor by using a turbulence reducer; means for removing the water in the cistern from about 15 cm below the water surface; means for filtering the removed water for sediments, wherein the sediments have a size of at least 50 microns; and means for activated-carbon filtering the water that has been filtered for sediments.

Finally, in one exemplary embodiment a device for modifying the direction and speed of a water flow falling into a vertical pipe is claimed, said device comprising: a hollow polyhedron-shaped housing defined by two pyramids, one upper pyramid and one lower pyramid joined by its base, wherein both pyramids are truncated, thus defining the floor and the ceiling of the housing, wherein the water enters the housing by means of or via an orifice in the ceiling; a projection on the housing floor, wherein said projection is pyramid shaped, thus defining an inner pyramid; wherein the degree of inclination of the inner pyramid is substantially the same as the degree of inclination of the upper pyramid, wherein the upper pyramid comprises at least one window on at least one of its faces, and/or the upper, lower, and inner pyramid comprise at least one edge rounded by a preset radius. Wherein: the angle of inclination of the inner pyramid is 53±5° (corresponding to Q3=180°−(53±5°)); the angle of inclination of the lower pyramid is different from the angle of inclination of the upper pyramid; the upper pyramid and the lower pyramid are pyramids truncated at the same height; the upper pyramid and the lower pyramid are pyramids truncated at a different height; the upper pyramid and the lower pyramid are triangular pyramids; the inner pyramid is a truncated pyramid; the preset radius of the rounded edges is at least 2 cm; the area of at least one of the windows is greater than the area of the orifice through which the water enters; and/or at least one of the faces of the upper pyramid comprises a mark to cut said at least one window.

One skilled in the art will appreciate that the pipe diameters and pipe elements used herein may vary without affecting the subject matter of this invention, and that pipes with diameters smaller than, greater than or equal to 2″ may be used in the main downspout/riser pipe (wherein, in an exemplary embodiment, the three-way connection would be larger than said diameter) and that diameters smaller than, greater than, or equal to ¾″ may be used in the main riser pipe. All these operating diameters, widely known in the art, may vary according to the system capacity.

One skilled in the art will appreciate that the features shown for the turbulence reducer 60 also apply for the three dimensions, that is, not only for “X” and “Y”, but also for “X”, “Y” and “Z”, in addition to their respective planes and sub-planes. Furthermore, one skilled in the art will appreciate that the shape and/or volumetric capacity of the diverter container 10 may vary without affecting the subject matter of the present invention.

In one exemplary embodiment, pipe 5 comprises a plurality of perforations located at different heights of pipe 5, each perforation further comprising a removable lid, wherein said lid provides for a tight seal to each corresponding perforation.

In one exemplary embodiment, at least one material for manufacturing diverter container 10, pipe 5 and/or turbulence reducer 60 is selected from the list of: high density polyethylene, low density polyethylene, high density polypropylene, low density polypropylene, bituminous elastomer, polyvinyl chloride, any UV-resistant, hypoallergenic, thermoformable polymer, and/or any combination thereof. However, one skilled in the art will appreciate that the material for manufacturing diverter container 10, pipe 5 and/or turbulence reducer 60 may vary without affecting the subject matter of the present invention. In a particular embodiment, the material that diverter container 10, pipe 5 and/or turbulence reducer 60 is made of is about 4±1 mm thick.

The foregoing description of the various embodiments has been presented only for purposes of illustration and description. Said embodiments are not intended to be exhaustive or to limit the invention to the ways disclosed. Therefore, many modifications and variations will become apparent to those skilled in the art. Moreover, the foregoing disclosure is not intended to limit the present invention.

1-20. (canceled)

21. A system for diverting an adjustable amount of water, wherein rainwater runs through a main pipe, said system comprising:
at least one closed diverter container, wherein said diverter container has a maximum height and volumetric capacity, a lower part of said diverter container comprises at least one water outlet valve, and an upper part of said diverter container comprises at least one water inlet defined by an orifice having a preset area and shape on the diverter container surface;
one pipe per the at least one closed diverter container, said pipe including a length at least partially similar to the height of the diverter container, and including an area and shape substantially equal to that of the water inlet orifice where the pipe is vertically inserted, such that the pipe is attached to the diverter container, with the pipe lower end remaining inside and at the lower part of the diverter container, and with the pipe upper end remaining at least at level with the diverter container upper surface; and
at least one three-way connection, wherein the first and second outlets of said at least one three-way connection are attached to the main pipe through which water flows in the direction from the first outlet to the second outlet, such that the third outlet of said at least one three-way connection is pointing downwardly and is attached to the upper end of the corresponding pipe of said at least one diverter container;
wherein the said at least one three-way connection is above said at least one diverter container.

22. The system according to claim 21, wherein the pipe section inside the corresponding diverter container comprises a perforation made at a preset height, wherein said height corresponds to a preset volume of water to be diverted.

23. The system according to claim 21, wherein the pipe comprises a plurality of perforations closed with removable lids.

24. The system according to claim 21, wherein the three-way connection is a T-type connection.

25. The system according to claim 21, wherein the three-way connection is a Y-type connection.

26. The system according to claim 21, wherein the operating diameter of the three-way connection is greater than the operating diameter of the main pipe.

27. The system according to claim 21, wherein the diverter container comprises a cavity.

28. The system according to claim 21, wherein the attachment is provided by via a sealing ring.

29. The system according to claim 21, wherein the attachment further allows for the pipe to at least partially slide when the pipe is pulled out or pushed into the diverter container.

30. The system according to claim 21, wherein the third downwardly pointing outlet of the three-way connection is attached to the upper end of the corresponding pipe of at least two diverter containers via a secondary pipe.

31. The system according to claim 21, wherein the pipe upper end comprises either a nipple or a coupling.

32. The system according to claim 21, wherein the first and second outlets of said at least one three-way connection are attached to the main pipe via eccentric reductions.

33. The system according to claim 32, wherein the eccentric reductions of the second outlet of said at least one three-way connection is pointing upwardly.

34. The system according to claim 32, wherein the eccentric reductions of the first outlet of said at least one three-way connection is pointing downwardly.

35. The system according to claim 21, wherein the water outlet valve of the diverter container comprises at least the opening, closing and partial closing stages.

36. The system according to claim 21, wherein the third at least partially downwardly pointing outlet of said at least one three-way connection further comprises a check valve.

37. The system according to claim 21, wherein the first outlet of a subsequent three-way connection is connected to the second outlet of a previous three-way connection, such that the third at least partially downwardly pointing outlet in each three-way connection is attached to the upper end of the corresponding pipe of at least one diverter container.

38. The system according to claim 21, wherein:
the third at least downwardly pointing outlet of the three-way connection is attached to the upper end of the corresponding pipe of at least two diverter containers via a secondary pipe; and
the first outlet of a subsequent three-way connection is connected to the second outlet of a previous three-way connection, such that the third at least partially downwardly pointing outlet in each three-way connection is attached to the upper end of the corresponding pipe of at least one diverter container.

39. The system according to claim 21, wherein the water outlet of at least a first diverter container is connected to the pipe of at least a second diverter container.

40. The system according to claim 39, wherein the second diverter container is below the first diverter container.
